(19) United States
(12) Patent Application Publication
(10) Pub. No.: US 2015/0208012 A1
(43) Pub. Date: Jul. 23, 2015

(54) MULTI-PURPOSE HANDHELD ELECTRONIC COMMAND AND CONTROL DEVICE WITH ERGONOMIC FEATURES

(71) Applicant: Tara Chand Singhal, Torrance, CA (US)

(72) Inventor: Tara Chand Singhal, Torrance, CA (US)

(21) Appl. No.: 14/160,739

(22) Filed: Jan. 22, 2014

(51) Int. Cl. H04N 5/44; G06F 3/047

(52) U.S. Cl. CPC H04N 5/4403; G06F 3/047; G09G 2300/04; H04N 2005/443; H04N 2005/4408

(57) ABSTRACT

A multi-purpose handheld electronic device with ergonomic features for a handheld device is described. This device may be configured or reconfigured for multiple uses that may include a remote control device, a WIFi phone device, a gaming device, a data entry and data display device, and a video display device. Some of the unique features of this device are directed to ergonomic features of the device. These are size and shape of the device, as well as placement of controls on the device.

### CROSS REFERENCE

This application claims priority from U.S. provisional application Ser. No. 61/847,716 filed Jul. 7, 2013 of Tara Chand Singhal, titled “System and Method for Ergonomic Features of an Electronic Handheld Multi-purpose Device”. The application Ser. No. 61/847,716 is incorporated herein by reference.

This application is related to and also claims priority from U.S. application Ser. No. 12/454,345 filed May 15, 2009, titled “Apparatus and Method for Touch Screen User Interface for Handheld Electronic Devices Part I” of Tara Chand Singhal. The application Ser. No. 12/454,345 is incorporated herein by reference.

This application is related to and also claims priority from U.S. application Ser. No. 12/456,009 filed Jun. 10, 2009, titled “Apparatus and Method for Touch Screen User Interface for Handheld Electronic Devices Part II” of Tara Chand Singhal. The application Ser. No. 12/456,009 is incorporated herein by reference.

### FIELD OF THE INVENTION

A multi-purpose handheld electronic device that functions as a universal remote control, as a WiFi data device, as a WiFi communication device, as a gaming device, and that has ergonomic visual and operational features is described.

### BACKGROUND

Prior art teaches a universal remote control device. A universal remote control device is used to control multiple home appliances such as television, recording systems and music systems. Some universal remotes are also used to control home lighting and security systems. These universal remotes have many functions, control switches, and buttons. The upper surface of the remote is occupied entirely by these switches and controls. Some devices also have a display window on the upper surface.

Separate and apart from the universal remotes, prior art teaches WiFi data access devices that may also be used as WiFi phones. Prior art also teaches touch control display screens on handheld devices.

It is the objective of the embodiments herein to make multi-purpose remote control devices with functions that include internet access and WiFi phones. It is yet another objective to provide improved man machine interface in the form of improved ergonomic features and functions that simplify the use and operation of these handheld devices.

### SUMMARY

Embodiments for a multi-purpose handheld electronic device with ergonomic features are described. This device may be configured or reconfigured for multiple uses that may include a universal remote control device for televisions, recording systems, music systems, light systems, security systems and other appliances and devices inside a home, a WiFi phone device, a gaming device, an Internet connected data entry and display device, and a video recording and playback device.

Some of the unique features of the embodiments of the handheld device are directed to ergonomic features of the device in how it is hand-held and used. These ergonomic features relate to size and shape of the device, placement of controls on the device, as well as how the controls are integrated with the operational features of the device. The device has a display screen that also functions as a touch screen. The entire top surface of the device is a display/touch screen.

Prior art modern handheld electronic devices such as smart phones now operate exclusively via touch screen using a finger or a thumb or a combination of fingers such as in zoom and thus obviate the need for a traditional prior art free moving cursor.

However, this feature of exclusively using a finger and a thumb in the form of touch control, while it may work well in some situations, in general has some drawbacks; such as, small limited size screens, with limited size of icons making it hard to precisely touch a part of the screen all the time.

Earlier prior art devices, given this drawback, used a stylus which could more precisely touch an area of the limited size touch screen. However, carrying or using a stylus is also not used in modern handheld devices, in preference to finger-operated touch control.

Hence in modern devices it may be a drawback to use a touch screen as it requires a finger or a thumb to operate by touching a part of the screen. Furthermore, for many people, using a finger requires use of two hand operation, where one hand is used to hold the device and the index finger of the other hand is used to touch, swipe, or select from the display screen.

Therefore, while in some situations a touch on a screen is not a desirable form of touch-control, in other situations it is a desirable form of control. Prior art free moving cursor icon has its own ergonomic issues in moving and positioning such a free moving cursor and is not useful in limited size screen devices.

Therefore embodiments herein teach devices with hybrid controls that use both a finger-touch control as well a thumb-touch control operated cursor that alleviates the concerns of prior art free moving cursor on the limited screen size handheld devices.

That is, in different embodiments the display/touch screen of the handheld device is used differently. In some embodiments, such as in remote control embodiments, both touch control and cursor control are simultaneously operable enabling a user to use touch control where preferred and use cursor control where that is preferable or exclusively switch from one to the other use.

The hybrid controls as described above are arranged on the upper surface of the device for ergonomic use, on the screen of the device, when the device is handheld cradled between the palm and the fingers of the hand, and where the thumb is naturally positioned on the upper surface, as would be explained later. The entire display surface is a touch surface.

The device being a handheld device, the overall size of the device is important. For ergonomic reasons, the size of the device in width is substantially limited to be between 2 and 3.5 inches and notionally may be 2.75 inches making it easy to hold in the hand when the device is cradled and supported by the fingers and supported by the palm, leaving the thumb of the same hand to be able to reach the controls on the device.

Also for ergonomic reasons, the size in length of the device is limited to be notionally 6 inches again making it easy to hold and operate in the hand. The thickness of the device is notionally limited to be ½ inch or less.

It should be kept in mind the width, thickness, and length limitations of the device are applicable to the size of the device's screen and where it is assumed that the screen size and the overall device size are very close to each other.

Further, as an added optional feature, the display screen of the device may be slightly curved. Such a curvature enables the longitudinal far edges of the screen to be a little closer to the viewer's eyes when the device is held either vertically or horizontally in the hand. That is, such a curvature of the screen makes the entire screen surface in longitudinal direction equal distance to the eyes. New prior art AMOLED display screen technology makes curved screens possible.

AMOLED (active-matrix organic light-emitting diode) is a display technology for use in mobile devices and televisions. OLED describes a specific type of thin-film-display technology in which organic compounds form the electroluminescent material, and active matrix refers to the technology behind the addressing of pixels.

As of 2012, AMOLED technology is used in mobile phones, media players and digital cameras. The two primary TFT backplane technologies, namely polycrystalline silicon (poly-Si) and amorphous silicon (a-Si), are used today in AMOLEDs. These technologies offer the potential for fabricating the active-matrix backplanes directly onto flexible plastic substrates for producing flexible AMOLED displays.

Some other unique ergonomic features of the device are the placement and positioning of the touch controls. These touch-controls include a bounded touch control area (BTA) of the size, notionally of, ¾ inch square that functions or simulates prior art functions of a cursor control and item selection functions.

The BTA may be placed or positioned on any part of the screen. There may be two different BTA's that may be positioned near the edges of the screen when the device is held horizontally in both hands, enabling the thumb tip of both hands to operate the device features. In some embodiments, the BTA may be placed somewhere in the middle of the screen to be conveniently accessed when the device is held vertically in the hand, enabling a thumb to operate the BTA.

Another unique aspect of the device is the use of a hop-box cursor operable with the bounded touch area control (BTA). The box cursor operates in conjunction with the BTA and selects and activates one of the displayed icons of the display screen in lieu of directly touching that item on the screen. When the displayed icons are relatively small for a finger selection, this feature would be useful in quickly hop-positioning the box cursor on the icon and activating the icon function using the BTA.

The BTA may be minimized and is maximized when needed enabling the entire display screen to be used for display operation. That may be useful in watching a video or playing a game.

Prior pending applications of the inventor, U.S. application Ser. No. 12/454,345 filed May 15, 2009 and U.S. application Ser. No. 12/456,009 filed Jun. 10, 2009 that are referenced in the Cross-Reference section, teach the art related to use of hop-box cursor and bounded touch control area (BTA) in handheld devices.

These and other aspects of the embodiments herein are further described in detail with the help of the accompanying drawings and the description, where similar number are used to identify the features of the embodiments.

### BRIEF DESCRIPTION OF THE DRAWINGS

Some of the novel features of the embodiments will be best understood from the accompanying drawings, taken in conjunction with the accompanying description, in which similar reference characters refer to similar parts, and in which:

FIGS. 1A and 1B are block diagrams that illustrate hardware and operational features of the present embodiments of an electronic handheld device.

FIGS. 1C and 1D are block diagrams that illustrate additional hardware and operational features of the present embodiments of an electronic handheld device.

FIGS. 2A and 2B are block diagrams that illustrate functional and operational features of a preferred embodiment of an electronic handheld device for a television remote control application.

FIGS. 2C and 2D are block diagrams that illustrate additional functional and operational features of a preferred embodiment of an electronic handheld device for a television remote control function.

FIGS. 3A and 3B are block diagrams that illustrates functional and operational features of a preferred embodiment of an electronic handheld device for a DVR remote control function.

FIGS. 4A and 4B are block diagrams that illustrates functional and operational features of a preferred embodiment of an electronic handheld device for a home Light and Security remote control function.

FIGS. 5A and 5B are block diagrams that illustrates functional and operational features of a preferred embodiment of an electronic handheld device for a data device for access to a wireless network.

FIGS. 6A and 6B are block diagrams that illustrates functional and operational features of a preferred embodiment of an electronic handheld device for a data device for access to a wireless network for use as a phone.

FIGS. 7A and 7B are block diagrams that illustrates functional and operational features of a preferred embodiment of an electronic handheld device for a game device.

### DESCRIPTION

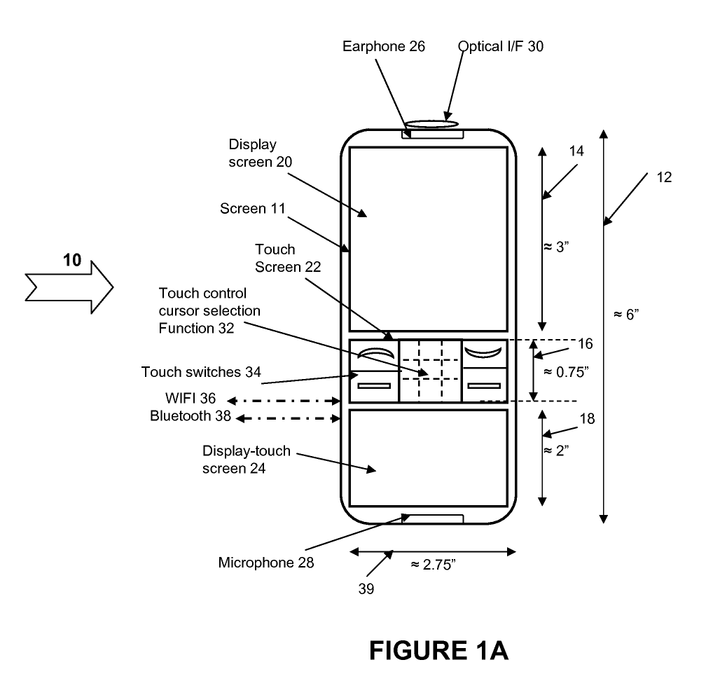

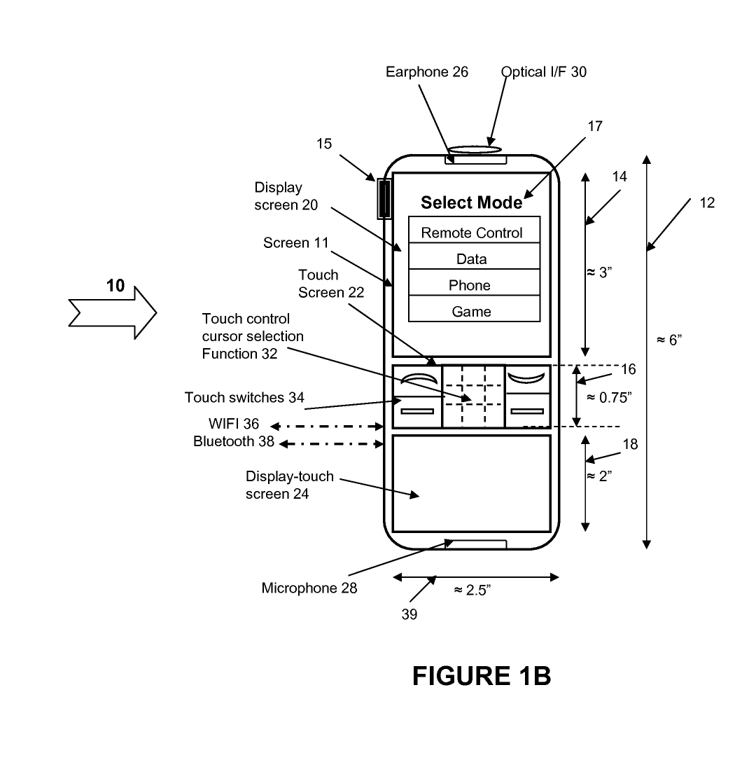

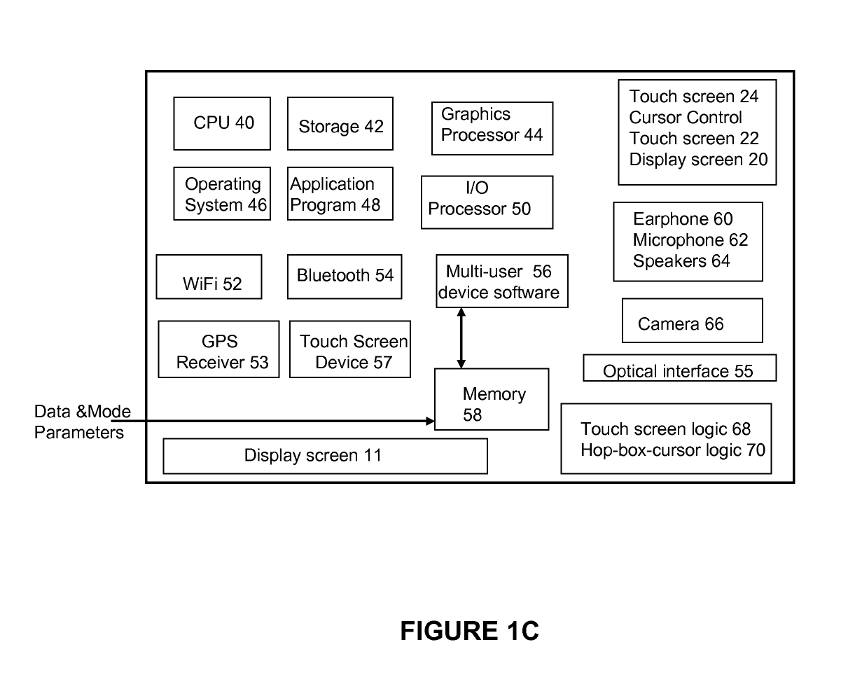

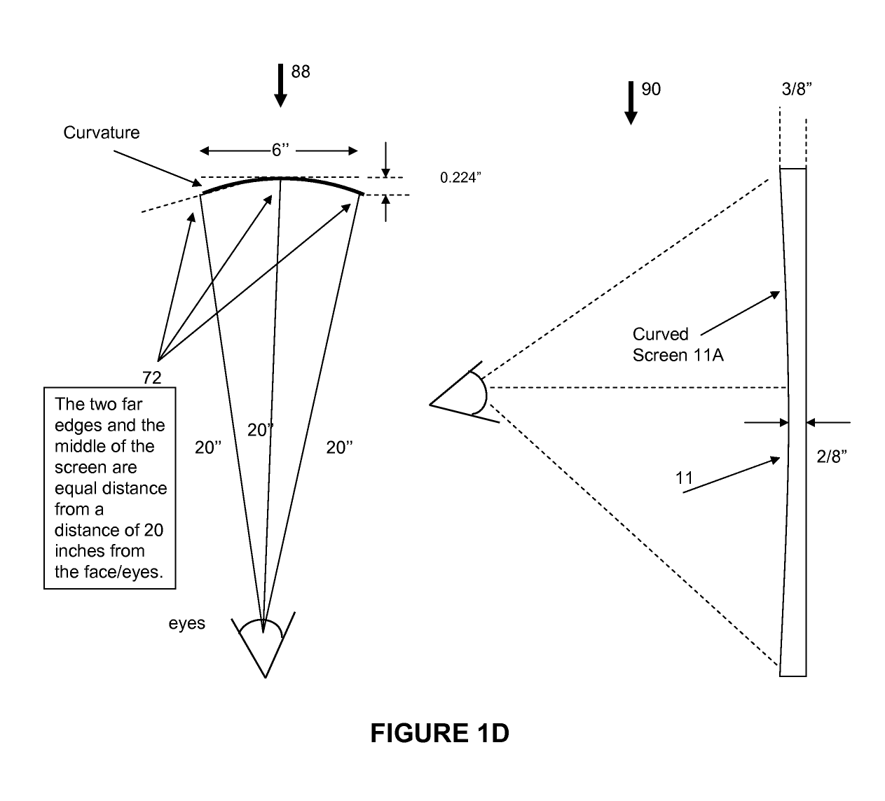

As initially illustrated with the help of FIG. 1A, a multi-purpose handheld electronic device 10 is described. There are different embodiments of device 10, as later illustrated. Some of these embodiments are directed to the hardware and electronic features of the device, while other embodiments are directed to the functional features of the device.

The hardware features relate to the different sensors and input and output interfaces that may be used in the device. The functional features of the device are provided via different application software that would be resident in the memory of the device and operating there from in the device.

FIGS. 1A, 1B, 1C, and 1D illustrate the hardware and electronic features of the handheld device that may be common to the different embodiments.

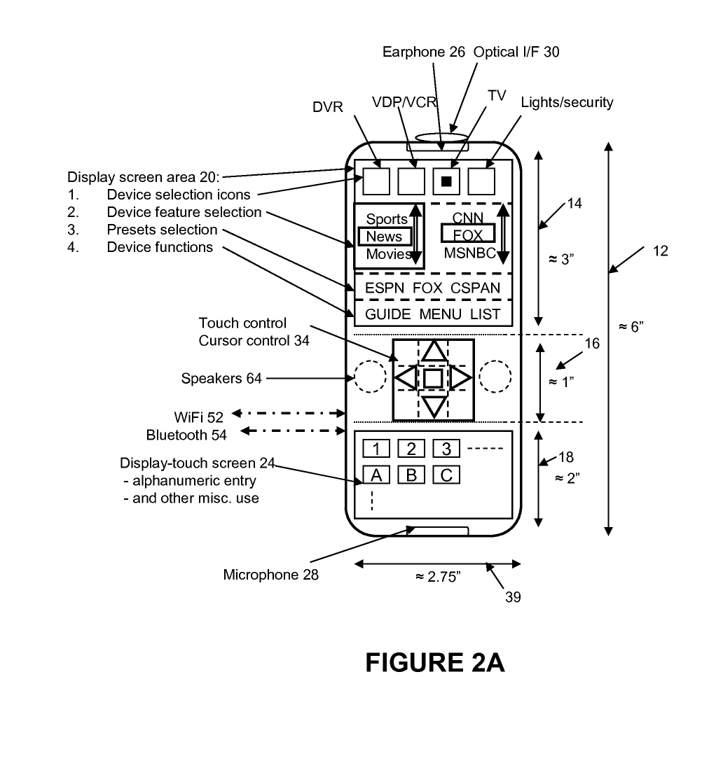

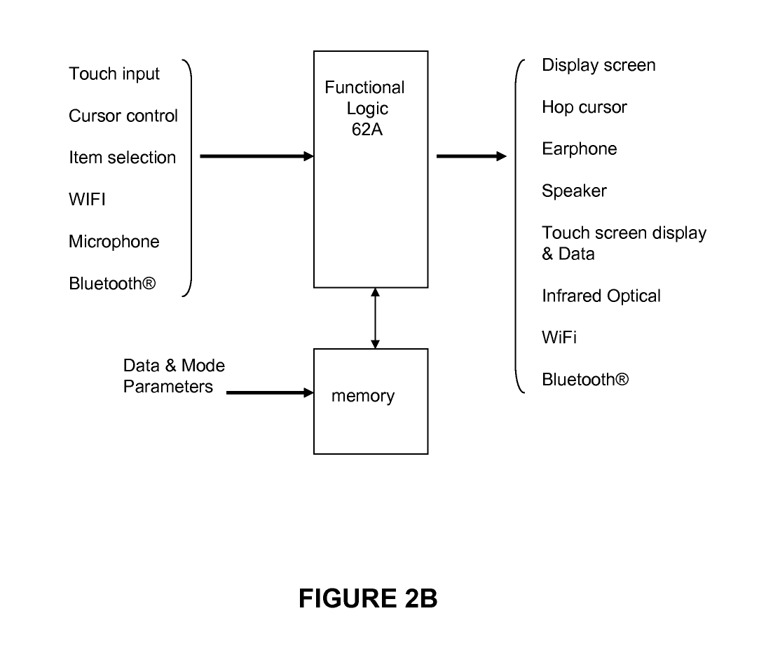

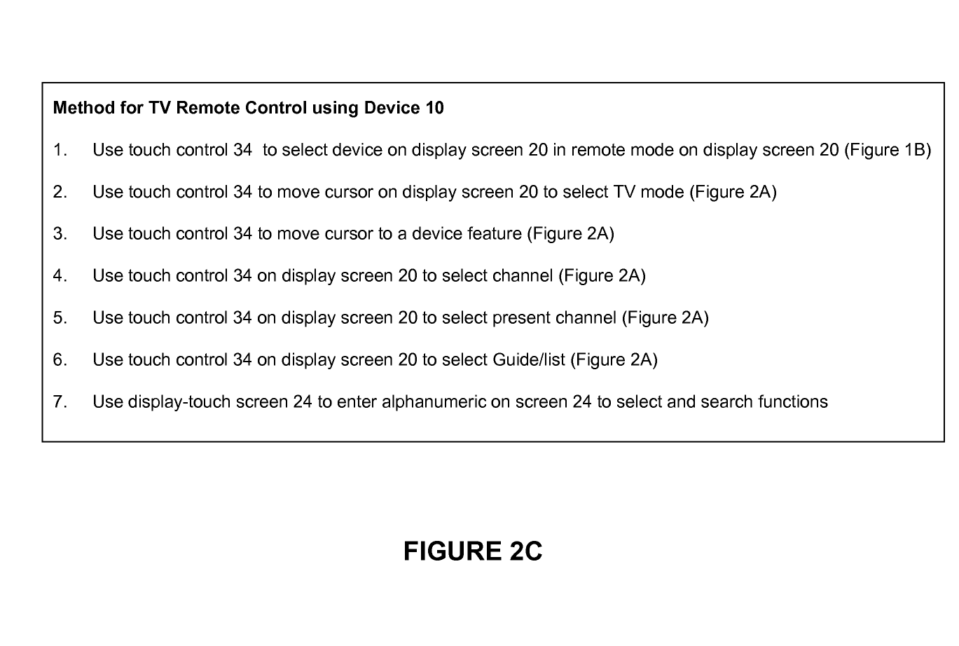

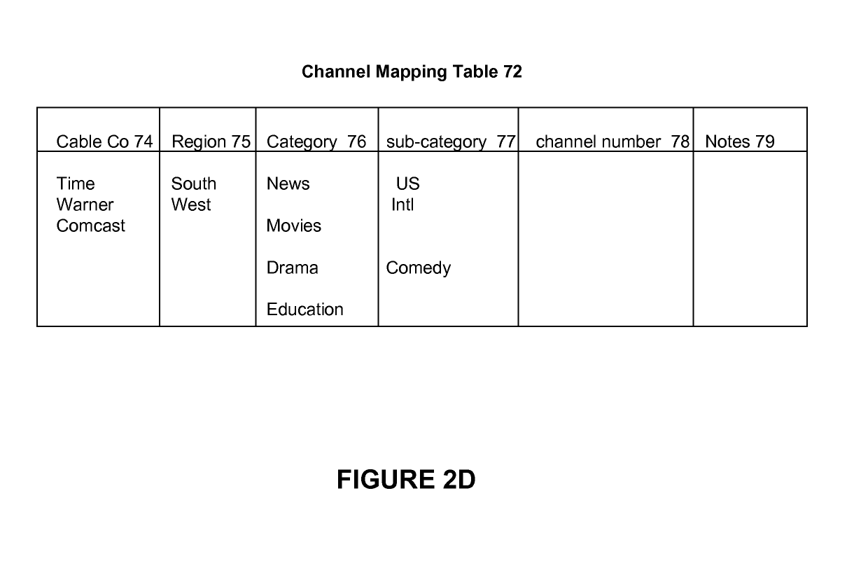

FIGS. 2A, 2B, 2C and 2D illustrate functional and operational features of a device operating in remote control mode.

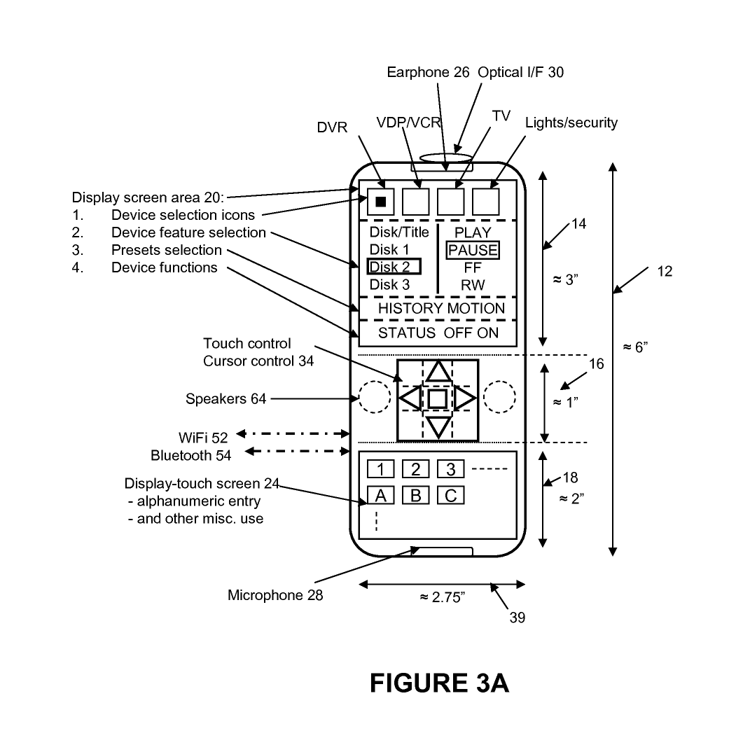

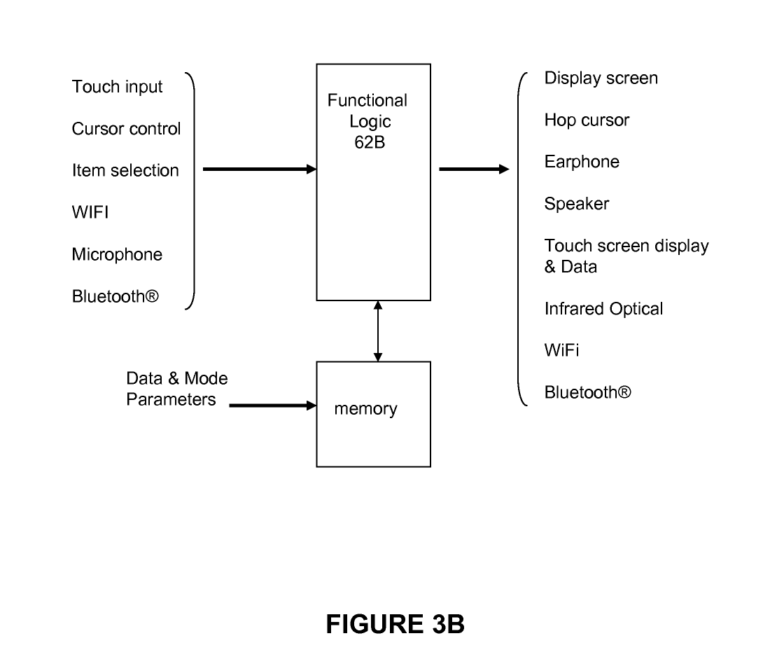

FIGS. 3A and 3B illustrate the functional and operational features of the device operating in DVR remote control Mode.

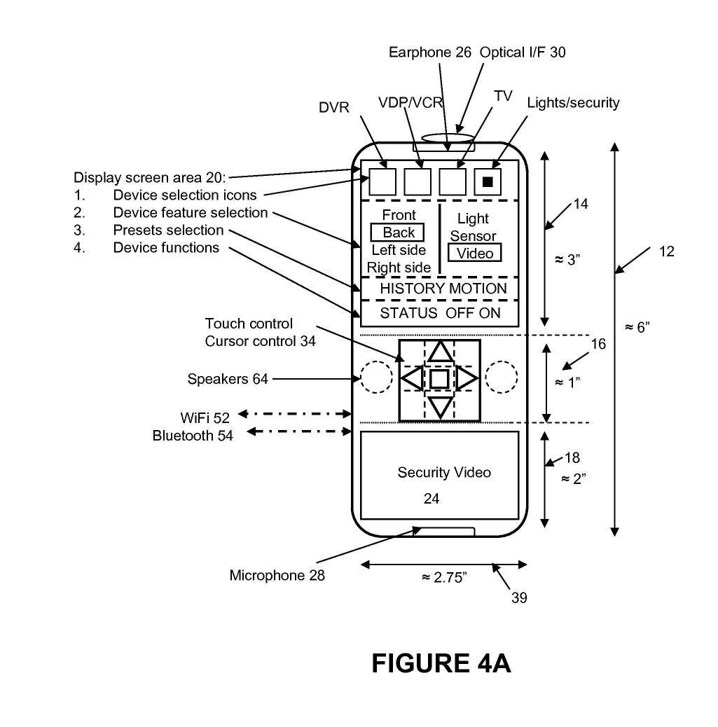

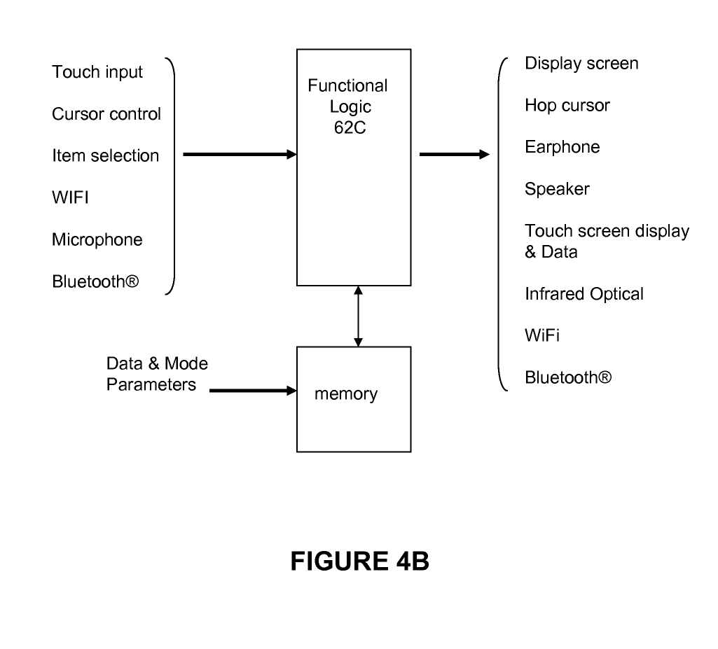

FIGS. 4A and 4B illustrate the functional and operational features of the device operating in Home Light/Security remote control mode.

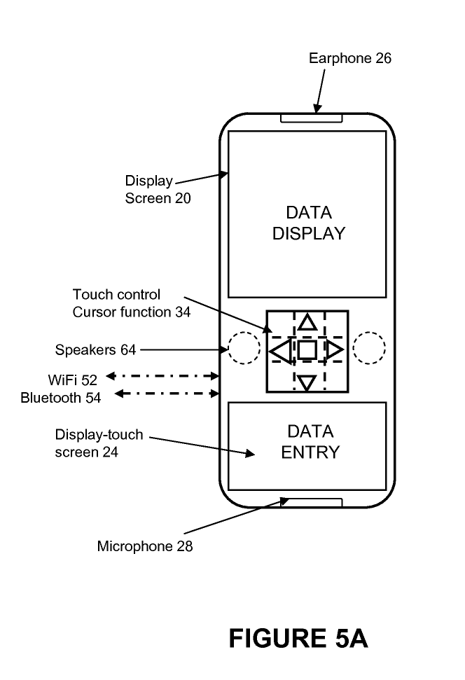

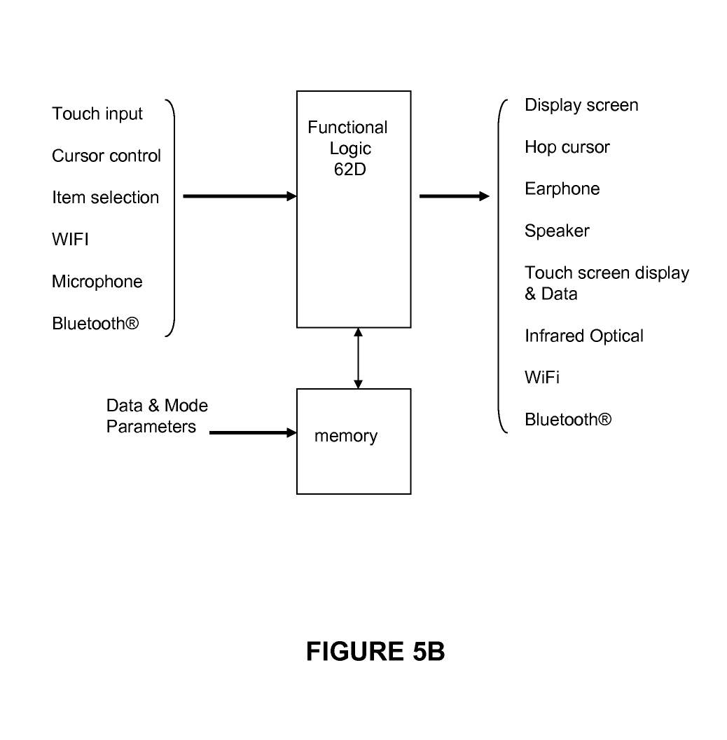

FIGS. 5A and 5B illustrate the functional and operational features of the device operating in the data mode for receiving and displaying data from the Internet via a WiFi interface.

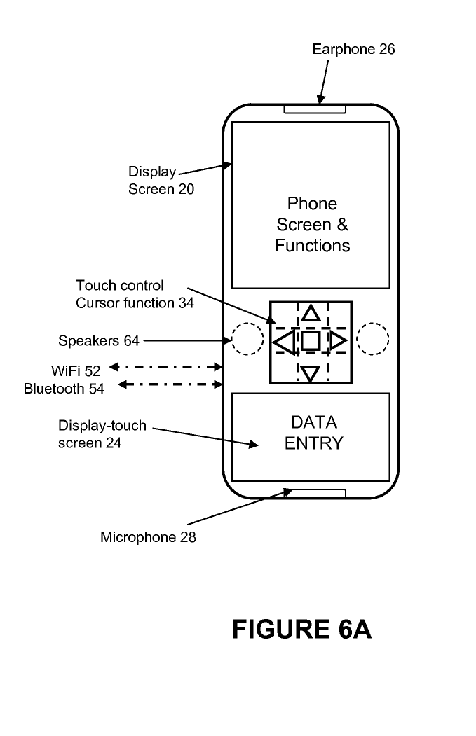

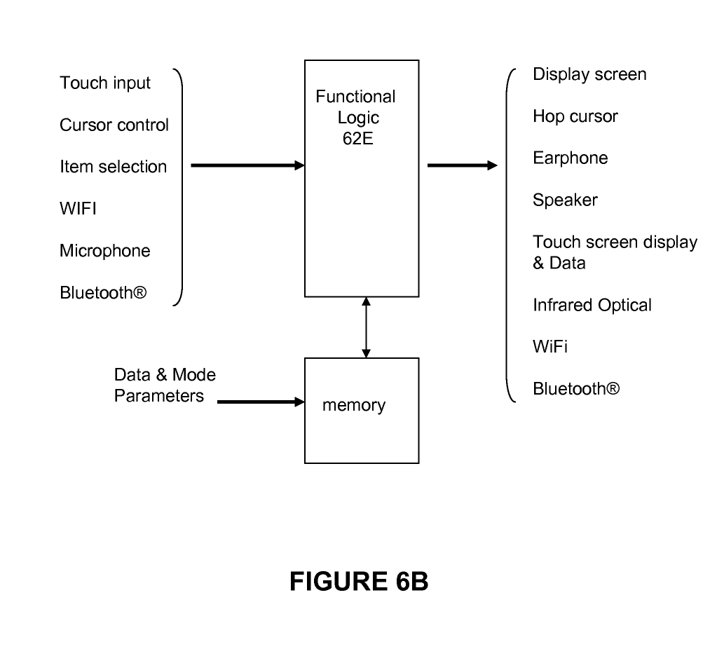

FIGS. 6A and 6B illustrate the functional and operational mode for the device operating in the phone mode. The phone mode may be operable exclusively via a WiFi interface or in combination with a cellular interface as in smart phones.

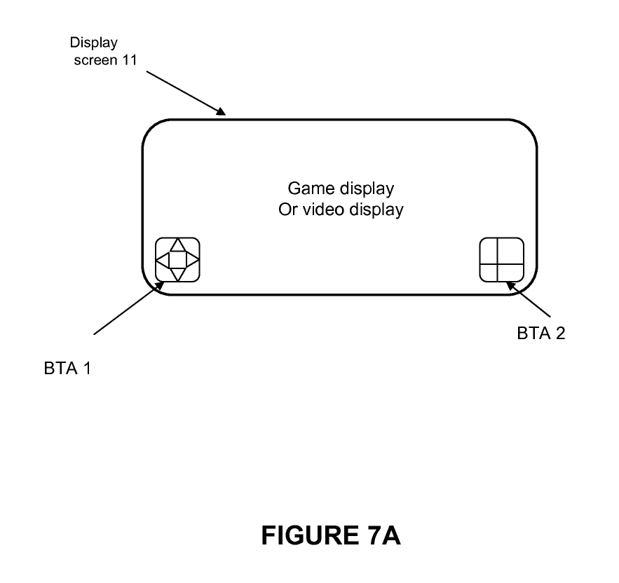

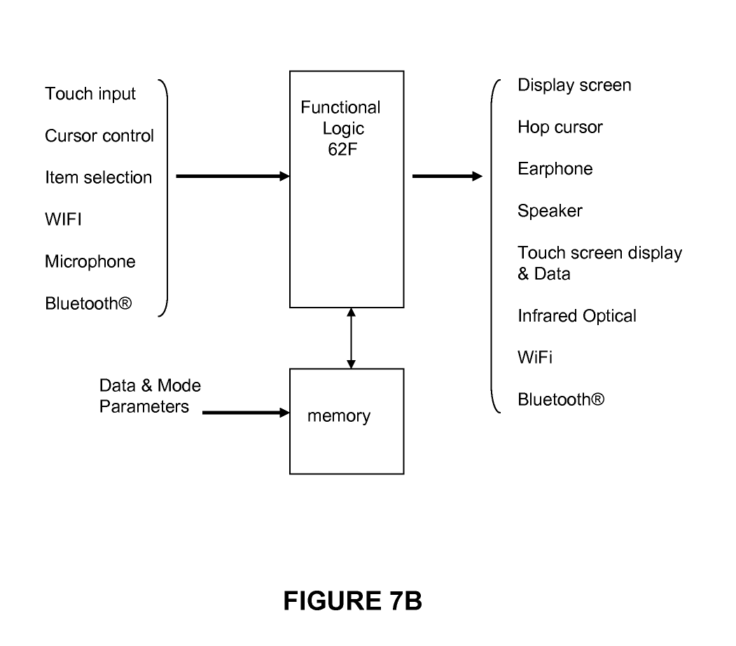

FIGS. 7A and 7B illustrate the functional and operational mode for the device operating in the game mode. The game mode may be both or either without Internet access or with internet access, as some games can be played without Internet access while some other games require Internet access.

These and other aspects are described in detail here where the headings are provided for reader convenience.

### Hardware and Electronic Features:

As illustrated with the help of FIG. 1A, the device 10 is a handheld electronic multi-purpose use device. Being a handheld device, the size and shape of the device is important for ergonomic reasons. The width, thickness, and length of the device 10 are such that the device is able to be comfortably held in the palm of a hand.

When the device is held in the palm of the hand, the device is cradled by the fingers supported by the palm that leaves the thumb of the hand holding the device to be able to touch control the surface of the device. In this manner of holding the device, the device is operated by a thumb-tip of the hand in which the device is held, as the thumb is naturally positioned on the touch-screen surface on the topside of the device.

In some embodiments the device may be held in two hands and operated by both the left and the right hand thumbs. In other embodiments, the device may be held in one hand and operated by the finger of the other hand. Other manners of use are not ruled out and the device may be used in other ways than those described herein.

The device is not intended to be and is not a tablet computer and is also not a cellular telephone device that is capable of making a telephone connection. However the device 10 is WiFi capable and can use that capability to make internet originated telephone calls. Therefore the device can be operated anywhere for different reasons and for internet access where ever WiFi signals are available. However, the device may also have an optional cellular connection that may be used in some embodiments.

For ergonomic reasons, the width of the device is limited to be between 2.0 and 3.5 inches and notionally may be 2.75 inches making it easy to hold in the palm of the hand. For ergonomic reasons, the length of the device is limited to be notionally 6 inches, making it easy to hold and operate the device in the hand as well as keep as an item of personal possession in the pocket or a ladies' purse. The thickness of the device is limited to be ½ inch or less and is notionally ⅜″ thick. In this size configuration the device 10 may be very much perceived to be the size of a smart phone.

With reference to FIG. 1A, the screen 11 of device is functionally portioned for many of the embodiments such as in remote control embodiments as illustrated later with the help of FIGS. 2A and 2B, into three separate screen areas that of, a display screen 20 near the top area of the device, control screen 22 near the middle of the device, and a display-touch screen 24, near the bottom area of the device. It should be noted that the entire screen 11 is a display and a touch screen and has been functionally portioned into these three screen areas as above.

It is believed that given the limited size of the display screen 20 and the device 10 being handheld, and the difficulty of touch-selecting small icons on the display screen 20, it is preferable to position a cursor control touch screen 22, near the middle of the device, with a bounded touch area (BTA) 32 for cursor control and other touch switches 34 near the middle of the screen as area 22 that would be used for and provides for touch control.

The touch screen area 22 has implemented a hop-box-cursor control making this type of cursor to be easily moved and positioned for item selection on the display screen 20, as opposed to touch-selecting an icon on the display screen 20 with a fingertip as a in prior art.

This improvement in the hop-box-cursor provides features that are not present in a freely moving cursor icon on a large screen as well as not present in touch-selecting an icon. Features of BTA and hop-box cursor have been described in pending applications of the inventor, as in the cross reference section.

The touch control area 22 has a plurality of touch switches 34 and a touch control cursor and selection switches 32. The touch switches 32 provides for four-direction slide touch movement and enable the cursor to be moved in four directions and a center touch selects the cursor highlighted item.

The width 39 of the device may be 2.75″; the length 12 of the device may be 6″; then the display screen 20 height 14 may be notionally 3″. Also, the display touch screen 24 height 18 may be 2″; the touch control 22 height 16 may be 0.75, where notionally, a 0.75″ square shape touch area provided for the cursor movement and item selection and control functions 32.

The touch control area 22 is thus positioned roughly or notionally in the middle of the device 10 making it natural to be able to position a thumb tip on the touch area 22 when the device 10 is held in the palm of the hand, while the display area 20 is on the top part of the device.

As illustrated in FIG. 1B, the device mode is touch selected by a display screen 20 which displays different modes of the device via a Select Mode function 17 function. Alternatively, the device mode may be selected via hop-box cursor operated by the touch control cursor function 32. Yet alternatively also, the mode of the device may be selected by hardware switch 15 on a side of the device 10. The hardware switch 15 may also be used to turn the device on or off.

As illustrated with the help of FIG. 1C, the device 10 has a display screen 11, display screen 20, cursor control touch screen 22, display-touch screen 24, graphics processor 44, I/O processor 50, microphone 62, earphone 60, speakers 64, and digital camera 66.

The device 10 also has wireless interfaces of WiFi 52, Bluetooth® 54, and infrared optical interface 55, GPS receiver 53. The device 10, in addition also has a CPU 40, RAM 58, storage memory 42 and an operating system 46. The device 10, in addition, may also have speech processing capability (not shown) in the form of text to speech and speech to text conversion logic.

The device 10, in addition also has multi-use device software 56, application programs 48, touch screen logic 68 and hop-box cursor logic 70.

As illustrated in FIG. 1C, hardware and software items in device 10 includes, a CPU 40, a data storage 42, a graphics processor 44, an operating system 46, an application program 48, an I/O processor 50, earphone 60, microphone 62, speakers 64, WiFi logic 52, GPS Receiver 53, Touch screen device 57, Bluetooth® function 54, optical interface 55, memory 58 and multi-use device software 56, camera 66, touch screen logic 68 and hop-box cursor logic 70, for operating the screen 11 into a touch screen 24, control screen 22 and display screen 20.

The memory 58 receives and stores parameters that enable the device operating system to emulate and simulate different operational modes of the device.

Each individual hardware item of the device as in FIG. 1C is prior art and no specific claim is made to any such individual item. The application software as also in FIG. 1C is based on prior art software technology that is commonly used in programming electronic devices. Hence no specific claim is made to such prior art software technology, except for the unique combination of the application software for its intended purpose in the handheld device 10.

As illustrated with the help of FIG. 1D and with the help of views 88 and 90, the display screen 11 surface may be a curved screen 11A with a curvature on each end of the screen 11. As illustrated in view 88, the degree of curvature is designed for the two far edges of the screen and the middle of the screen to be positioned at equal distance from the eyes or face. That is the entire screen surface 11A is at an equal distance 72 from the eyes when the device is held in the hand for operational use.

Assuming that the device 10 would be held in the hand at a distance of approximately twenty inches from the face, the simplified illustration of calculations herein provide for a curvature where each end of the screen is curved in by approximately 0.224 inches. Such a curvature has been arrived at using Pythagoras' theorem by calculating square root of (400 plus 9)=409=20.224″.

As illustrated in view 90, the thickness of the device 10 in the center may be less than the thickness of the device 10 at the far edges to create and or accommodate the curvature of the display screen.

### TV Remote Control Mode

An embodiment of device 10 for a remote control function is illustrated with the help of FIGS. 2A and 2B. Such an embodiment may be used for controlling a television, a video disc recorder, a video cassette recorder, and a light system and or security systems.

It is to be understood by those skilled in the art that controlling a TV directly is same as controlling a TV via a cable set top box, except that a set top box provides for a much larger number of viewer channels that usually number in a few thousand and very hard to keep track which channel number is assigned to which programming.

As illustrated in FIG. 2A, in this embodiment, the device screen 11, is notionally 6 inches in height 12. The width 39 of the device 10 is notionally 2.75 inches.

The device screen 11 is portioned into three different operational areas. The top area 20, notionally three inches in height 14, is used as a display only and is used to display the functions of a remote control device. A middle area 22, notionally one inch in height 16, is used for touch controls by providing a bounded touch area 34, and a bottom area 24, notionally two inches in height 18, is used for data entry via touch control for an alpha-numeric keypad.

The display area 20 positioned near the top of the display screen 11 is portioned into four different display sub-areas. These sub-areas include (1) a device selection icons sub-area, (2) device feature selection sub-area, (3) preset selections sub-area, and (4) a device functions sub-area. These sub-areas may be different or more or less than what has been illustrated here.

The device selection sub-area (1) provides for making a selection among the choices of DVR, VDP/VCR, TV, and Light/Security mode. The feature section sub-area (2) displays list menus that help select a channel. One of these list menus is a category list that groups the available channels in categories.

The categories may include groups such as Sports, Drama, News, Government, Education etc. If there are a large number of channels in a category, there may be sub-categories within a category. For example, if there are a large number of movie channels, the sub-categories may include Family, Drama, Fiction, Action, adventure etc. Use of cursor may select any of these hierarchical lists of channels by name of the channel.

It should be understood by those skilled in the art, that there may be more functions that those illustrated here that may be used for different set-top boxes from different cable and satellite companies.

Also there may be a search function (not shown) that may be used to search the device memory for any number of items such as channel name, movie name etc.

Each of the category lists is separately scrolled to find the channel name to be selected among a large number of channels. This arrangement of categories may help a user quickly select the channel they wish to watch.

As illustrated in FIG. 2B, function logic 62A, receives touch inputs, cursor control commands, item selection command, microphone input, and WiFi input. The function logic 62A controls the device 10 and outputs to display screen, the hop cursor, earphone, speaker, touch screen display, infra red commands, WiFi data and Bluetooth interface data.

Similar logic is prior art and is commonly used in many applications. Such prior art logic is customized to the specific application as had been explained with the help of FIGS. 2A, 2C and 2D.

The third sub-area (3) is for the presets that help quickly select a prior selected channel. The fourth sub-area (4) is for functions of the TV mode that may include volume, mute etc.

The device also provides a hopping box-cursor function that is operated with the help of touch cursor control switches in the middle of the screen. The hop-box-cursor function is operable by a thumb tip positioned on the touch switches 32 on the touch area 22, when the device is held in the palm of the hand, to be able to quickly find and select a channel.

The hop-box cursor makes it convenient to select an area of the display screen without using a stylus or a finger. In that fashion, the display area 20 acts only as a display screen and not as a touch screen.

The bottom screen 24 may be used as a touch screen for alphanumeric entry data. The data that is entered on screen 24 may be displayed on the same screen 24 or on the display screen 20.

As a large number of users of such devices communicate via text messages, a text message function may be implemented via Internet with a WiFi connection obviating the need for a cellular connection. That is, in some modes there may be a text function operated by a provider via the Internet or WIFi as opposed to a cellular connection.

FIG. 2C provides an illustration of the method steps that may be used to use the device 10 in universal remote mode as a TV remote control. These method steps, where all the steps may not be used or used in the order specified, are:
1. Use touch control 34 to select device on display screen 20 in remote mode on display screen 20 (FIG. 1B)
2. Use touch control 34 to move cursor on display screen 20 to select TV mode (FIG. 2A)
3. Use touch control 34 to move cursor to a device feature (FIG. 2A)
4. Use touch control 34 on display screen 20 to select channel (FIG. 2A)
5. Use touch control 34 on display screen 20 to select present channel (FIG. 2A)
6. Use touch control 34 on display screen 20 to select Guide/list (FIG. 2A)
7. Use display-touch screen 24 to enter alphanumeric on screen 24 to select and search functions.

As illustrated in FIG. 2D, to facilitate such category lists and a channel selection, the device memory stores and provides a mapping table 72. The table 72 has cable Co 74, geographic regions 75, channel category 76, channel sub-category 77, channel number 78 and notes 79.

The table 72 helps identify a channel number to tune to, without knowing the channel numbers, by selecting the category and subcategory of the programming and thus the category and names of these channels enable a selection to be made without knowing the actual channel number. Further, the device may store channel mapping for different broadcast companies in different regions of the country.

The device 10 also may have a GPS receiver and a GPS function. There may be a function in the device 10 that would sense the geographic region using the GPS function and map that to the cable provider in that region using table 72 and thus automatically customize the device for use for the appropriate cable provider for that region.

### DVR Remote Control Mode

A DVR remote control function is illustrated with the help of FIGS. 3A and 3B. This function in many aspects is similar to the one described above for television, except customized to the operation of a DVR, such as FF, RW, STOP, Play Pause and record functions of the DVR.

As illustrated in FIG. 3B, function logic 62B, receives touch inputs, cursor control commands, item selection command, microphone input, and WiFi input. The function logic 62B controls and outputs to display screen, the hop cursor, earphone, speaker, touch screen display, infra red commands, WiFi data and Bluetooth interface data. Similar logic is prior art and is commonly used in many applications. Such prior art logic is customized to the specific application as had been explained with the help of FIGS. 2A, 2C and 2D.

### Home Security Remote Control Mode

A home security remote control function is illustrated with the help of FIGS. 4A and 4B. This function in many aspects is similar to the one described above for DVR, except customized for the operation of the lights and the security system.

The security features may include, monitoring and controlling different sensors that would be positioned around the house, both inside and outside. These sensors may be motion, smoke, carbon monoxide, temperature, humidity and any other sensors that may be used for monitoring the safety and security of the home and its occupants.

The device 10 can also display on display screen 24, live video being captured by any of the security cameras and automate the programming of on/off of the various lights both external and internal of the house.

As illustrated in FIG. 4B, function logic 62C, receives touch inputs, cursor control commands, item selection command, microphone input, and WiFi input. The function logic 62C controls and outputs to display screen, the hop cursor, earphone, speaker, touch screen display, infra red commands, WiFi data and Bluetooth interface data. Similar logic is prior art and is commonly used in many applications. Such prior art logic is customized to the specific application as had been explained with the help of FIGS. 2A, 2C and 2D.

### WiFi Data Mode

A WiFi data mode function is illustrated with the help of FIGS. 5A and 5B. This function in many aspects is similar to the one described above for home security, except customized for the operation of connecting to the Internet via WiFi. The device 10 can receive and display web page content and perform other functions of search and command etc.

As illustrated in FIG. 5B, function logic 62D, receives touch inputs, cursor control commands, item selection command, microphone input, and WiFi input. The function logic 62D controls and outputs to display screen, the hop cursor, earphone, speaker, touch screen display, infra red commands, WiFi data and Bluetooth interface data. Similar logic is prior art and is commonly used in many applications. Such prior art logic is customized to the specific application as had been explained with the help of FIGS. 2A, 2C and 2D.

### WiFi Telephone Capable Mode

A WiFi mode home security remote control function is illustrated with the help of FIGS. 6A and 6B. The device screen is portioned into three different areas. The top area is used as a display area only and is used to display the functions of a telephone device, a middle area that provides for touch controls and a bottom area that provides for data entry via touch control for an alphanumeric keypad.

As illustrated in FIG. 6B, function logic 62E, receives touch inputs, cursor control commands, item selection command, microphone input, and WiFi input. The function logic 62E controls and outputs to display screen, the hop cursor, earphone, speaker, touch screen display, infra red commands, WiFi data and Bluetooth interface data. Similar logic is prior art and is commonly used in many applications. Such prior art logic is customized to the specific application as had been explained with the help of FIGS. 2A, 2C and 2D.

### Game Capable Mode

A game mode function is illustrated with the help of FIGS. 7A and 7B. The game mode may be best operable in a landscape orientation holding the device when the device is held in both hands. The game controls are positioned on two sides of the device and include BTA touch controls.

As illustrated in FIG. 7B, function logic 62E, receives touch inputs, cursor control commands, item selection command, microphone input, and WiFi input. The function logic 62E controls and outputs to display screen, the hop cursor, earphone, speaker, touch screen display, infra red commands, WiFi data and Bluetooth interface data. Similar logic is prior art and is commonly used in many applications. Such prior art logic is customized to the specific application as had been explained with the help of FIGS. 2A, 2C and 2D.

A multi-purpose handheld electronic device has a substantially rectangular-shape, substantially flat, elongated handheld electronic device body with a front side and a back side, designed to be held in the palm of a human hand with the front side having substantially on the entire front side a display-touch screen that is viewable and accessible to a user for operational use and control of the device.

The display-touch screen of the device is functionally portioned into a display-only screen positioned near a top side of the front side, a touch-only surface for operational touch control positioned in a middle of the front side and a display-touch screen positioned near a bottom side of the front side.

The device has CPU, memory, functional logic, microphones, speakers, WIFI wireless transmitting receiving electronics, short distance RF electronics, optical transmitting/receiving electronics, GPS, the device is capable of functioning in a multi mode use, including at least as a universal remote control and status device.

The display-only screen displays device status and operational features of remotely controlled devices. The touch-only surface provides for a touch cursor control interface for control of a hop cursor that is displayed on the display-only screen, where the control interface enables display and selection of the operational features of the remotely controlled devices on the display-only screen.

The touch-only surface as a cursor control interface has a touch screen limited in area to one inch square that provides for a thumb-tip slide and touch control to operate a hop cursor on the display-only screen. The touch-only screen additionally includes touch controls for safety covered alarms and police/paramedic/fire request controls.

The display-touch screen displays alphanumeric icons that enable data entry into the device, and alternatively used as a video display for display of videos.

The device for universal remote user interface function has the display-only screen visually partitioned into a (i) control area for a controlled device to be selected, (ii) a control features area for the selected device, (iii) a preset selection feature area, and (iv) controlled device selections area, where the controlled device to be selected area includes choices of, TV, DVR, light system, appliance, and security system.

The display-only screen is sloped downward that provides an ergonomic viewing angle access to viewable display-only area of the display screen. Te touch-only screen positioned in the middle of the device provides substantially flat surface for ergonomic touch access to the touch-only segment of the device. The display-touch screen is sloped upward that provides for an ergonomic viewing angle and for access to the display-touch screen.

The device is for use as a universal remote control, a use as a communication device, a use as a data storage device, a use as a computing device, and use as a security system device.

The remote control device for use as a TV remote control has the logic that maps a channel selection to a pre-stored channel number when a channel by channel category and channel name in the category is selected. The logic provides an interface that groups the channels by a title category and selects a category and a specific channel in the category to select a channel via the television remote device that facilitates a channel section from a large number of channels numbering in hundreds. The logic sends an optical transmission command for that channel number to the television.

The remote control device for a TV has the memory that stores a table that maps channel category, channel name and channel number. The table is updatable via the WIFI interface to a server on a global computer network.

A remote control device for a TV has a storage memory with table that maps channel number to channel name, and each channel name to a channel category for each television service provider. A logic operating in a processor of the device and a display screen that enables the device to display a list of channel names by a selected channel category. The table is updatable via the WIFI interface to a server on a global computer network.

The table has plurality of columns with titles of (i) geographic region (ii) cable provider (iii) channel category (iv) sub-categories for each category (v) channel name and (vi) channel number, enabling a user to carry the device and use it in any location as a remote control device. The device has a GPS function to set the geographic region.

The remote control device for a TV, when a channel by channel category and channel name in the category is selected, the logic maps the selection to a pre-stored channel number. The logic sends an optical transmission command for that channel number to the television, thereby provides a man-machine interface that groups the channels by a title category and select a category and a specific channel in the category to select a channel via the television remote device that facilitates a channel section from a large number of channels numbering in thousands.

A handheld electronic device has a substantially rectangular-shape, substantially flat, elongated handheld electronic device body with a front side and a back side, designed to be held in the palm of a human hand with the front side positioned substantially on its entire side a display-touch screen that is viewable and accessible to a user for operational control of the device. The display-touch screen is curved in the elongated side and when the device is held either in the portrait orientation or a landscape orientation or in either orientation, the entire screen surface is equal distance from a human face.

The screen provides for a viewing screen surface that is equal distance to a human face from a top area of the screen, a middle area of the screen and a bottom area of the screen, thereby providing an ergonomic viewing angle for the entire screen area.

The device held at a distance of substantially 20 inches from a human face, the screen provides for a viewing screen surface that is equal distance of 20 inches to a human face from a top area of the screen, a middle area of the screen and a bottom area of the screen, thereby providing an ergonomic viewing angle for the entire screen area.

The device held at a distance of substantially 20 inches from a human face, the outer edges of the screen and the center of the screen are at an equal distance from the face by curving the screen in an arc of a circle of 20 inches radius.

A multi-purpose handheld electronic device has a substantially rectangular-shape, substantially flat, elongated handheld electronic device body with a front side and a back side, designed to be held in the palm of a human hand with the front side having substantially on the entire front side a display-touch screen that is viewable and accessible to a user for operational use and control of the device.

The display-touch screen is functionally portioned into a display-only screen positioned near a top side of the front side, a touch-only surface for operational touch control positioned in a middle of the front side and a display-touch screen positioned near a bottom side of the front side.

The device has CPU, memory, functional logic, microphones, speakers, WIFI wireless transmitting receiving electronics, short distance RF electronics, optical transmitting/receiving electronics, the device capable of functioning in a multi mode use, including at least as a universal remote control and status device.

The display-only screen displays device status and operational features of remotely controlled devices. The touch-only surface provides for a touch cursor control interface for control of a hop cursor that is displayed on the display-only screen, where the control interface enables display and selection of the operational features of the remotely controlled devices on the display-only screen.

The touch-only surface as a cursor control interface has a touch screen limited in area to one inch square that provides for a thumb-tip slide and touch control to operate a hop cursor on the display-only screen.

The display-touch screen displays alphanumeric icons that enable data entry into the device, and alternatively used as a video display for display of videos.

The device for universal remote user interface function has the display-only screen visually partitioned into a (i) control area for a controlled device to be selected, (ii) a control features area for the selected device, (iii) a preset selection feature area, and (iv) controlled device selections area, where the controlled device to be selected area includes choices of, TV, DVR, light system, appliance, and security system.

The touch-only screen additionally includes touch controls for safety covered alarms and police/paramedic/fire request controls.

The display-only screen is sloped downward that provides an ergonomic viewing angle access to viewable display-only area of the display screen. The touch-only screen positioned in the middle of the device provides substantially flat surface for ergonomic touch access to the touch-only segment of the device. The display-touch screen is sloped upward that provides for an ergonomic viewing angle and for access to the display-touch screen.

The device may be used as a universal remote control, a use as a communication device, a use as a data storage device, a use as a computing device, and use as a security system device.

The logic maps a channel selection to a pre-stored channel number when a channel by channel category and channel name in the category is selected. The logic provides an interface that groups the channels by a title category and selects a category and a specific channel in the category to select a channel via the television remote device that facilitates a channel section from a large number of channels numbering in hundreds. The logic sends an optical transmission command for that channel number to the television.

The memory stores a table that maps channel category, channel name and channel number. The table is updatable via the WIFI interface to a server on a global computer network.

A remote control device for a TV has a storage memory with table that maps channel numbers to channel names, and each channel name to a channel category for each television service provider. A logic operating in a processor of the device and a display screen that enables the device to display a list of channel names by a selected channel category. The table is updatable via the WIFI interface to a server on a global computer network. The table is searchable via a search function with fields of channel name, channel category, and program name.

The table has plurality of columns with titles of (i) geographic region (ii) cable provider (iii) channel category (iv) a sub-category for each category (v) channel name and (vi) channel number, enabling a user to carry the device and use it in any location as a remote control device. The device has a GPS function to set the geographic region.

When a channel by channel category and channel name in the category is selected, the logic maps the selection to a pre-stored channel number. The logic sends an optical transmission command for that channel number to the television, thereby provides a man-machine interface that groups the channels by a title category and select a category and a specific channel in the category to select a channel via the television remote device that facilitates a channel section from a large number of channels numbering in thousands.

16. A handheld electronic device has a substantially rectangular-shape, substantially flat, elongated handheld electronic device body with a front side and a back side, designed to be held in the palm of a human hand with the front side positioned substantially on its entire side a display-touch screen that is viewable and accessible to a user for operational control of the device. The display-touch screen is curved in the elongated side and when the device is held either in the portrait orientation or a landscape orientation or in either orientation, the entire screen surface is equal distance from a human face.

The screen provides for a viewing screen surface that is equal distance to a human face from a top area of the screen, a middle area of the screen and a bottom area of the screen, thereby providing an ergonomic viewing angle for the entire screen area.

The handheld electronic device, for the device held at a distance of substantially 20 inches from a human face, the screen provides for a viewing screen surface that is equal distance of 20 inches to a human face from a top area of the screen, a middle area of the screen and a bottom area of the screen, thereby providing an ergonomic viewing angle for the entire screen area.

The device held at a distance of substantially 20 inches from a human face, the outer edges of the screen and the center of the screen are at an equal distance from the face by curving the screen in an arc of a circle of 20 inches radius.

In summary, the preferred embodiments are on ergonomic features of a multi-purpose handheld electronic device that provides for a display-only, touch-control only and display-touch data entry portions via a display-touch screen. The device is capable of being used in applications such as universal remote control, as a WIFI device for the Internet, as a data entry device . . . .

While the particular invention, as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

1. A multi-purpose handheld electronic device comprising:
a. a substantially rectangular-shape, substantially flat, elongated handheld electronic device body with a front side and a back side, designed to be held in the palm of a human hand with the front side having substantially on the entire front side a display-touch screen that is viewable and accessible to a user for operational use and control of the device;
b. the display-touch screen is functionally portioned into a display-only screen positioned near a top side of the front side, a touch-only surface for operational touch control positioned in a middle of the front side and a display-touch screen positioned near a bottom side of the front side;
c. the device has CPU, memory, functional logic, microphones, speakers, WIFI wireless transmitting receiving electronics, short distance RF electronics, optical transmitting/receiving electronics, the device capable of functioning in a multi mode use, including at least as a universal remote control and status device.

2. The device as in claim 1, comprising:
a. the display-only screen displays device status and operational features of remotely controlled devices;
b. the touch-only surface provides for a touch cursor control interface for control of a hop cursor that is displayed on the display-only screen, where the control interface enables display and selection of the operational features of the remotely controlled devices on the display-only screen.

3. The device as in claim 1, comprising:
the touch-only surface as a cursor control interface has a touch screen limited in area to one inch square that provides for a thumb-tip slide and touch control to operate a hop cursor on the display-only screen.

4. The device as in claim 1, comprising:
the display-touch screen displays alphanumeric icons that enable data entry into the device, and alternatively used as a video display for display of videos.

5. The device as in claim 1, comprising:
the device for universal remote user interface function has the display-only screen visually partitioned into a (i) control area for a controlled device to be selected, (ii) a control features area for the selected device, (iii) a preset selection feature area, and (iv) controlled device selections area, where the controlled device to be selected area includes choices of, TV, DVR, light system, appliance, and security system.

6. The device as in claim 1, comprising:
the touch-only screen additionally includes touch controls for safety covered alarms and police/paramedic/fire request controls.

7. The device as in claim 1, comprising:
a. the display-only screen is sloped downward that provides an ergonomic viewing angle access to viewable display-only area of the display screen;
b. the touch-only screen positioned in the middle of the device provides substantially flat surface for ergonomic touch access to the touch-only segment of the device;
c. the display-touch screen is sloped upward that provides for an ergonomic viewing angle and for access to the display-touch screen.

8. The device as in claim 1, comprising:
a use as a universal remote control, a use as a communication device, a use as a data storage device, a use as a computing device, and use as a security system device.

9. The remote control device for a TV, as in claim 1, comprising:
a. the logic maps a channel selection to a pre-stored channel number when a channel by channel category and channel name in the category is selected;
b. the logic provides an interface that groups the channels by a title category and select a category and a specific channel in the category to select a channel via the television remote device that facilitates a channel section from a large number of channels numbering in hundreds;
c. the logic sends an optical transmission command for that channel number to the television.

10. The remote control device for a TV, as in claim 1, comprising:
a. the memory stores a table that maps channel category, channel name and channel number;
b. the table is updatable via the WIFI interface to a server on a global computer network.

11. A remote control device for a TV, comprising:
a. a storage memory with table that maps channel numbers to channel names, and each channel name to a channel category for each cable/satellite service provider;
b. a logic operating in a processor of the device and a display screen that enables the device to display a list of channel names by a selected channel category.

12. The remote control device for a TV, as in claim 11, comprising:
the table is updatable via the WIFI interface to a server on a global computer network.

13. The remote control device for a TV, as in claim 11, comprising:
the table is searchable via a search function with fields of channel name, channel category, and program name.

14. The remote control device for a TV, as in claim 11, comprising:
the table has plurality of columns with titles of (i) geographic region (ii) cable provider (iii) channel category (iv) a sub-category for each category (v) channel name and (vi) channel number, enabling a user to carry the device and use it in any location as a remote control device.

15. The remote control device for a TV, as in claim 11, comprising:
the device has a GPS function to set the geographic region.

16. The remote control device for a TV, as in claim 11, comprising:
a. when a channel by channel category and channel name in the category is selected, the logic maps the selection to a pre-stored channel number;
b. the logic sends an optical transmission command for that channel number to the television, thereby provides a man-machine interface that groups the channels by a title category and select a category and a specific channel in the category to select a channel via the television remote device that facilitates a channel section from a large number of channels numbering in thousands.

17. A handheld electronic device, comprising:
a. a substantially rectangular-shape, substantially flat, elongated handheld electronic device body with a front side and a back side, designed to be held in the palm of a human hand with the front side positioned substantially on its entire side a display-touch screen that is viewable and accessible to a user for operational control of the device;
b. the display-touch screen is curved in the elongated side and when the device is held either in the portrait orientation or a landscape orientation or in either orientation, the entire screen surface is equal distance from a human face.

18. The handheld electronic device, as in claim 17, comprising:
the screen provides for a viewing screen surface that is equal distance to a human face from a top area of the screen, a middle area of the screen and a bottom area of the screen, thereby providing an ergonomic viewing angle for the entire screen area.

19. The handheld electronic device, as in claim 18, comprising:
for the device held at a distance of substantially 20 inches from a human face, the screen provides for a viewing screen surface that is equal distance of 20 inches to a human face from a top area of the screen, a middle area of the screen and a bottom area of the screen, thereby providing an ergonomic viewing angle for the entire screen area.

20. The handheld electronic device, as in claim 18, comprising:
for the device held at a distance of substantially 20 inches from a human face, the outer edges of the screen and the center of the screen are at an equal distance from the face by curving the screen in an arc of a circle of 20 inches radius.
